(19) United States
(12) Patent Application Publication
(10) Pub. No.: US 2020/0174640 A1
(43) Pub. Date: Jun. 4, 2020

(54) TOUCH SCREEN AND DISPLAY DEVICE

(71) Applicant: Wuhan China Star Optoelectronics Semiconductor Display Technology Co., Ltd., Wuhan (CN)

(72) Inventor: Yalong MA, Wuhan (CN)

(21) Appl. No.: 16/319,479

(22) PCT Filed: Dec. 26, 2018
(86) PCT No.: PCT/CN2018/123797

§ 371 Date: Jan. 22, 2019

(30) Foreign Application Priority Data
Dec. 3, 2018 (CN) 201811465106.3

(51) Int. Cl. G06F 3/041; G06F 3/044

(52) U.S. Cl. CPC G06F 3/04164; G06F 3/04166; G06F 3/0446; G06F 3/0443

(57) ABSTRACT

Provided are a touch screen and a display device. The touch screen includes: thin film transistors and touch control electrodes disposed on the substrate, and the substrate includes signal channels for transmitting or receiving the touch control electrode capacitive signal in time division and control channels for controlling on and off of the thin film transistors; sources of at least two of the thin film transistors connect one signal trace to one signal channel; gates of the at least two of the thin film transistors connect one control trace to one control channel; one touch control electrode is connected to a drain of one thin film transistor.

### FIELD OF THE INVENTION

The present application relates to a touch control technology field, and more particularly to a touch screen and a display device.

### BACKGROUND OF THE INVENTION

At present, if a self-capacitive touch screen needs to implement multi-touch (such as five-points touch control), single-layer matrix touch control electrodes are needed. Each touch control electrode needs a corresponding signal channel, and when a finger touches, the signal amount of the touch control electrode in the finger area is changed, thereby determining the touch position; since each touch control electrode is independent, it can support multi-touch because the interference with each other will not occur.

Because the number of channels of the matrix touch control electrodes is too large, to achieve the same precision as the mutual capacitive touch screen, a number of channels far more than that of the mutual capacitive touch screen is required; generally, the number of channels required for the matrix self-capacitive touch screen is large, which makes the integrated circuit size larger, and also causes a larger number of bonded terminals, thereby increasing the difficulty of bonding.

Therefore, the prior art possesses drawbacks and is in urgent need of improvement.

### SUMMARY OF THE INVENTION

The present application provides a touch screen and a display device, which can reduce a number of channels required for a single-layer matrix self-capacitive touch screen, thereby meeting a requirement of a smaller size of an integrated circuit and greatly reducing difficulty of bonding.

To solve the aforesaid problem, the technical solution provided by the present application is described as follows:

The present application provides a touch screen, including:

a substrate, including a touch area and a bonding area on a side of the touch area, wherein the bonding area includes signal channels and control channels;

a thin film transistor layer, including thin film transistors which are spaced apart;

a touch control layer, including touch control electrodes distributed in an array;

signal traces, wherein one end of one of the signal traces is connected to sources of at least two of the thin film transistors, and another end of the one of the signal traces is connected to one of the signal channels;

control traces, wherein one end of one of the control traces is connected to gates of the at least two of the thin film transistors, and another end of the one of the control traces is connected to one of the control channels;

one of the touch control electrodes is connected to a drain of one of the thin film transistors;

wherein a sum of a number of the control channels and a number of the signal channels is smaller than a number of the touch control electrodes, and the control channels are used to control on and off of the thin film transistors, and the signal channels are used to transmit or receive capacitive signals of the touch control electrodes in time division to implement touch control.

In the touch screen of the present application, the control channels and the signal channels are used to respectively control the touch control electrodes of one row/column.

In the touch screen of the present application, one of the control channels is correspondingly connected to the gates of the thin film transistors of same row through one of the control traces, and one of the signal channels is correspondingly connected to sources of the thin film transistors of same column through one of the signal traces, and one of the thin film transistors is correspondingly connected to one of the touch control electrodes.

In the touch screen of the present application, when one of the control channels sends a control signal, the thin film transistors correspondingly connected to the control channel are all turned on, and the signal channel sends the capacitive signal to the touch control electrode corresponding to the control channel for charging and discharging.

In the touch screen of the present application, the control channel sends control signals to the thin film transistors row by row, and the signal channels simultaneously send the capacitive signal to the touch control electrode.

In the touch screen of the present application, the signal traces and the control traces are respectively located at gap positions between adjacent two rows/columns of the touch control electrodes.

In the touch screen of the present application, the signal traces are disposed across the control traces, and the signal traces are insulated from the control traces.

In the touch screen of the present application, the sum of the number of the control channels and the number of the signal channels is equal to a sum of a number of rows of the touch control electrodes and a number of columns of the touch control electrodes distributed in the array.

The present application further provides a display device, including a display panel and the touch screen according to claim 1, wherein the display panel includes a pixel unit, and the touch control electrodes are transparent electrodes, and the signal traces and the control traces are respectively located at gap positions between adjacent pixel units.

To solve the aforesaid problem, the present application further provides a touch screen, including:

a substrate, including a touch area and a bonding area on a side of the touch area, wherein the bonding area includes signal channels and control channels;

a thin film transistor layer, including thin film transistors which are spaced apart;

a touch control layer, including touch control electrodes distributed in an array;

signal traces, wherein one end of one of the signal traces is connected to sources of at least two of the thin film transistors, and another end of the one of the signal traces is connected to one of the signal channels;

control traces, wherein one end of one of the control traces is connected to gates of the at least two of the thin film transistors, and another end of the one of the control traces is connected to one of the control channels;

one of the touch control electrodes is connected to a drain of one of the thin film transistors;

wherein the control channels are used to control on and off of the thin film transistors, and the signal channels are used to transmit or receive capacitive signals of the touch control electrodes in time division to implement touch control.

In the touch screen of the present application, the control channels and the signal channels are used to respectively control the touch control electrodes of one row/column.

In the touch screen of the present application, one of the control channels is correspondingly connected to the gates of the thin film transistors of same row through one of the control traces, and one of the signal channels is correspondingly connected to sources of the thin film transistors of same column through one of the signal traces, and one of the thin film transistors is correspondingly connected to one of the touch control electrodes.

In the touch screen of the present application, when one of the control channels sends a control signal, the thin film transistors correspondingly connected to the control channel are all turned on, and the signal channel sends the capacitive signal to the touch control electrode corresponding to the control channel for charging and discharging.

In the touch screen of the present application, the control channel sends control signals to the thin film transistors row by row, and the signal channels simultaneously send the capacitive signal to the touch control electrode.

In the touch screen of the present application, the signal traces and the control traces are respectively located at gap positions between adjacent two rows/columns of the touch control electrodes.

In the touch screen of the present application, the signal traces are disposed across the control traces, and the signal traces are insulated from the control traces.

In the touch screen of the present application, the sum of the number of the control channels and the number of the signal channels is equal to a sum of a number of rows of the touch control electrodes and a number of columns of the touch control electrodes distributed in the array.

The benefits of the present application are: compared with the touch screen of the prior art, the touch screen and the display device provided by the present application are added with switch signals and utilize the control of the thin film transistors, and one channel can transmit and receive signals in time division for multiple touch control electrodes. Therefore, the number of channels required for the single-layer matrix self-capacitive touch screen is reduced, thereby reducing the integrated circuit size, reducing the number of terminals in the bonding area, and greatly reducing the difficulty of bonding.

### BRIEF DESCRIPTION OF THE DRAWINGS

In order to more clearly illustrate the embodiments of the present invention and the prior art, the following figures will be described in the embodiments and the prior art are briefly introduced. It is obvious that the drawings are only some embodiments of the present invention, those of ordinary skill in this field can obtain other figures according to these figures without paying the premise.

FIG. 1 is a partial structural view diagram of a liquid crystal display panel according to the first embodiment of the present application;

FIG. 2 is an enlarged view diagram of a region A in FIG. 1.

### DETAILED DESCRIPTION OF PREFERRED EMBODIMENTS

The following descriptions for the respective embodiments are specific embodiments capable of being implemented for illustrations of the present invention with referring to appended figures. The terms of up, down, front, rear, left, right, interior, exterior, side, etcetera are merely directions of referring to appended figures. Thus, the used directional terms are used to describe and understand the present invention, but the present invention is not limited thereto. In the figure, units with similar structures are denoted by the same reference numerals.

The present application is directed to the touch screen of the prior art, in which the number of channels required for the single-layer matrix self-capacitive touch screen is more, which leads to the technical problem of increasing the IC size, to increasing the number of terminals in the bonding area, and the difficulty in bonding. This embodiment can solve these drawbacks.

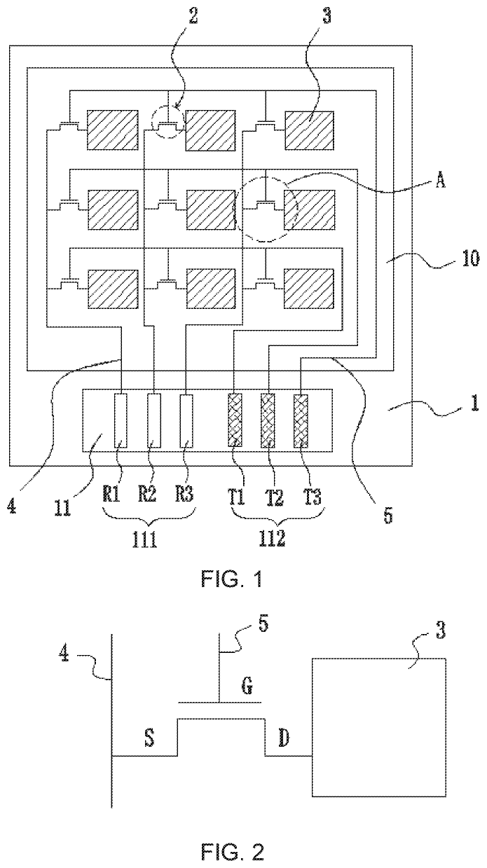

Please refer to FIG. 1, which is a structural diagram of a touch screen according to the embodiment of the present application. The touch screen of the embodiment is a single-layer matrix self-capacitive touch screen. In this embodiment, only nine touch control electrodes distributed in a 3×3 array are taken as an illustration for description.

In figure, the touch screen includes: a substrate 1, including a touch area 10 and a bonding area 11 on a side of the touch area 10, wherein the bonding area 11 includes signal channels 111 and control channels 112 which are spaced apart; a thin film transistor layer, which is fabricated on the substrate 1 and includes thin film transistors 2 which are spaced apart; a touch control layer, which is fabricated on the thin film transistor layer and includes touch control electrodes 3 corresponding to the touch area 10 to be distributed in an array; signal traces 4, wherein one end of one of the signal traces 4 is connected to sources of at least two of the thin film transistors 2, and the other end of the one of the signal traces is connected to one of the signal channels 111; control traces 5, wherein one end of one of the control traces 5 is connected to gates of the at least two of the thin film transistors 2, and the other end of the one of the control traces is connected to one of the control channels 112; besides, one of the touch control electrodes 3 is connected to a drain of one of the thin film transistors 2; wherein the control channels 112 are used to control on and off of the thin film transistors 2, and the signal channels 111 are used to transmit or receive capacitive signals of the touch control electrodes 3 in time division to implement touch control.

In one embodiment, the control channels 112 and the signal channels 111 are used to respectively control the touch control electrodes 3 of one row/column.

Specifically, as shown in figures, one of the control channels 112 is correspondingly connected to the gates of the thin film transistors 2 of same row through one of the control traces 5, and one of the control channels 112 is used to control on and off of one row of the thin film transistors 2. One of the signal channels 111 is correspondingly connected to sources of the thin film transistors 2 of same column through one of the signal traces 4, and the signal channel 111 is used to transmit a capacitance signal to a source of the thin film transistor 2, which is correspondingly turned on. One of the thin film transistors 2 is correspondingly connected to one of the touch control electrodes 3. Specifically, one of the touch control electrodes 3 is connected to a drain of one of the thin film transistors 2.

When one of the control channels 112 sends a control signal, the thin film transistors 2 correspondingly connected to the control channel 112 are all turned on, and the signal channel 111 sends the capacitive signal to the touch control electrode 3 corresponding to the control channel 3 for charging and discharging.

Specifically, in figures, as a first control channel T1 sends the control signal, the thin film transistors 2 of the lowermost row connected to the control channel T1 are all turned on, and a first signal channel R1, a second signal channel R2 and a third signal channel R3 simultaneously transmit capacitance signals to the thin film transistors 2 of the lowermost row to be sent to the touch control electrodes 3 of the lowermost row through the thin film transistors 2 for charging and discharging. The control channel 112 sends control signals to the thin film transistors 2 row by row, and the signal channel 111 simultaneously sends capacitive signals to the touch electrodes 3. Namely, as the first control channel T1 completes the transmission of the control signal, the control signals are sequentially sent by the second control channel T2 and the third control channel T3 to sequentially turn on the thin film transistors 2 of the corresponding rows. Then, he first signal channel R1, the second signal channel R2 and the third signal channel R3 send the capacitive signals to the touch control electrodes 3 of the corresponding rows. When the finger touches, the corresponding touch control electrode 3 forms a voltage difference, thereby implementing self-capacitive touch control.

The signal traces 4 and the control traces 5 are respectively located at gap positions between adjacent two rows/columns of the touch control electrodes 3. In figures, one of the control traces 5 is disposed between adjacent two rows of the touch control electrodes 3, and one of the signal traces 4 is disposed between adjacent two columns of the touch control electrodes 3. The signal traces 4 are disposed across the control traces 5, and the signal traces 4 are insulated from the control traces 5.

In this embodiment, a sum of a number of the control channels 112 and a number of the signal channels 111 is smaller than a number of the touch control electrodes 3. The number of the control channels 112 is equal to a number of rows of the touch control electrodes 3. The number of the signal channels 111 is equal to a number of columns of the touch control electrodes 3. The sum of the number of the control channels 112 and the number of the signal channels 111 is equal to a sum of the number of rows of the touch control electrodes 3 and the number of columns of the touch control electrodes 3 distributed in the array. A number of channels of the existing touch screen of the prior art is often equal to a product of a number of rows of the touch control electrodes and a number of columns of the touch control electrodes. Because the number of channels in the bonding area 11 of the present application is smaller, the number of bonded terminals and chip pins is also smaller, so that the requirement of the small size of the chip can be satisfied, and the process is simple and easy to bond.

In one embodiment, one and off of thin film transistors of the same row can be controlled by two control channels. Namely, one control channel is connected to a portion of the row of thin film transistors, and the other control channel is connected to the remaining portion of the row of thin film transistors. The two control channels simultaneously send control signals from both sides to the same row of thin film transistors, which can avoid signal delay caused by too many thin film transistors. The signal channels can also be similar to the design of the control channels.

Please refer to FIG. 2, which is an enlarged view diagram of a region A in FIG. 1. In figures, the signal trace 4 is connected to the source S of the thin film transistor. The control trace 5 is connected to the gate G of the thin film transistor. The drain D of the thin film transistor is connected to the touch control electrode 3. When the touch control operation is performed, the control trace 5 is used to transmit the control signal for controlling on or off of the thin film transistor, and the signal trace 4 is used to transmit the capacitor signal to be transmitted to the touch electrode 3 through the thin film transistor. A voltage signal is generated between the finger and the touch control electrode 3 when the finger touched, and the voltage signal is transmitted to the signal channel through the signal trace 4 for identifying the touch control. As performing a display operation, the thin film transistors are used to transmit a data signal and a scan signal, thereby realizing transmission of signals in time division.

The present application further provides a display device, including a display panel and the aforesaid touch screen, wherein the display panel includes a pixel unit, and the touch control electrodes are transparent electrodes, and the signal traces and the control traces are respectively located at gap positions between adjacent pixel units. The display device can be an external touch control or an in-cell touch control. The display panel may be a liquid crystal display panel or an OLED display panel. For details of the touch screen, refer to the description in the foregoing embodiments, and details are not repeated herein.

The touch screen and the display device provided by the present application are added with switch signals and utilize the control of the thin film transistors, and one channel can transmit and receive signals in time division for multiple touch control electrodes. Therefore, the number of channels required for the single-layer matrix self-capacitive touch screen is reduced, thereby reducing the integrated circuit size, reducing the number of terminals in the bonding area, and greatly reducing the difficulty of bonding.

In summary, although the above preferred embodiments of the present application are disclosed, the foregoing preferred embodiments are not intended to limit the invention, those skilled in the art can make various kinds of alterations and modifications without departing from the spirit and scope of the present application. Thus, the scope of protection of the present application is defined by the scope of the claims.

What is claimed is:

1. A touch screen, including:
a substrate, including a touch area and a bonding area on a side of the touch area, wherein the bonding area includes signal channels and control channels;
a thin film transistor layer, including thin film transistors which are spaced apart;
a touch control layer, including touch control electrodes distributed in an array;
signal traces, wherein one end of one of the signal traces is connected to sources of at least two of the thin film transistors, and another end of the one of the signal traces is connected to one of the signal channels;
control traces, wherein one end of one of the control traces is connected to gates of the at least two of the thin film transistors, and another end of the one of the control traces is connected to one of the control channels;
one of the touch control electrodes is connected to a drain of one of the thin film transistors;
wherein a sum of a number of the control channels and a number of the signal channels is smaller than a number of the touch control electrodes, and the control channels are used to control on and off of the thin film transistors, and the signal channels are used to transmit or receive capacitive signals of the touch control electrodes in time division to implement touch control.

2. The touch screen according to claim 1, wherein the control channels and the signal channels are used to respectively control the touch control electrodes of one row/column.

3. The touch screen according to claim 2, wherein one of the control channels is correspondingly connected to the gates of the thin film transistors of same row through one of the control traces, and one of the signal channels is correspondingly connected to sources of the thin film transistors of same column through one of the signal traces, and one of the thin film transistors is correspondingly connected to one of the touch control electrodes.

4. The touch screen according to claim 3, wherein when one of the control channels sends a control signal, the thin film transistors correspondingly connected to the control channel are all turned on, and the signal channel sends the capacitive signal to the touch control electrode corresponding to the control channel for charging and discharging.

5. The touch screen according to claim 4, wherein the control channel sends control signals to the thin film transistors row by row, and the signal channels simultaneously send the capacitive signal to the touch control electrode.

6. The touch screen according to claim 1, wherein the signal traces and the control traces are respectively located at gap positions between adjacent two rows/columns of the touch control electrodes.

7. The touch screen according to claim 6, wherein the signal traces are disposed across the control traces, and the signal traces are insulated from the control traces.

8. The touch screen according to claim 1, wherein the sum of the number of the control channels and the number of the signal channels is equal to a sum of a number of rows of the touch control electrodes and a number of columns of the touch control electrodes distributed in the array.

9. A display device, including a display panel and the touch screen according to claim 1, wherein the display panel includes a pixel unit, and the touch control electrodes are transparent electrodes, and the signal traces and the control traces are respectively located at gap positions between adjacent pixel units.

10. A touch screen, including:
a substrate, including a touch area and a bonding area on a side of the touch area, wherein the bonding area includes signal channels and control channels;
a thin film transistor layer, including thin film transistors which are spaced apart;
a touch control layer, including touch control electrodes distributed in an array;
signal traces, wherein one end of one of the signal traces is connected to sources of at least two of the thin film transistors, and another end of the one of the signal traces is connected to one of the signal channels;
control traces, wherein one end of one of the control traces is connected to gates of the at least two of the thin film transistors, and another end of the one of the control traces is connected to one of the control channels;
one of the touch control electrodes is connected to a drain of one of the thin film transistors;
wherein the control channels are used to control on and off of the thin film transistors, and the signal channels are used to transmit or receive capacitive signals of the touch control electrodes in time division to implement touch control.

11. The touch screen according to claim 10, wherein the control channels and the signal channels are used to respectively control the touch control electrodes of one row/column.

12. The touch screen according to claim 11, wherein one of the control channels is correspondingly connected to the gates of the thin film transistors of same row through one of the control traces, and one of the signal channels is correspondingly connected to sources of the thin film transistors of same column through one of the signal traces, and one of the thin film transistors is correspondingly connected to one of the touch control electrodes.

13. The touch screen according to claim 12, wherein when one of the control channels sends a control signal, the thin film transistors correspondingly connected to the control channel are all turned on, and the signal channel sends the capacitive signal to the touch control electrode corresponding to the control channel for charging and discharging.

14. The touch screen according to claim 13, wherein the control channel sends control signals to the thin film transistors row by row, and the signal channels simultaneously send the capacitive signal to the touch control electrode.

15. The touch screen according to claim 10, wherein the signal traces and the control traces are respectively located at gap positions between adjacent two rows/columns of the touch control electrodes.

16. The touch screen according to claim 15, wherein the signal traces are disposed across the control traces, and the signal traces are insulated from the control traces.

17. The touch screen according to claim 10, wherein the sum of the number of the control channels and the number of the signal channels is equal to a sum of a number of rows of the touch control electrodes and a number of columns of the touch control electrodes distributed in the array.
